(19) United States
(12) Patent Application Publication
(10) Pub. No.: US 2001/0015136 A1
(43) Pub. Date: Aug. 23, 2001

(54) Column for counter-currently contacting gas and liquid

(76) Inventor: Hugo Martijn Letzel, Amsterdam (NL)

Correspondence Address: Shell Oil Company, Legal-Intellectual Property, P.O. Box 2463, Houston, TX, 77252-2463, US

(21) Appl. No.: 09/757,888

(22) Filed: Jan. 10, 2001

(30) Foreign Application Priority Data
Feb. 16, 2000 (EP) 00200514.8

(51) Int. Cl. B01D 47/00

(52) U.S. Cl. 96/356

(57) ABSTRACT

A column is disclosed for counter-currently contacting gas and liquid comprising a plurality of horizontal contact trays arranged axially spaced apart in the column, each contact tray being provided with passages, and which column is further provided with a plurality of horizontal separation trays, each separation tray being spatially arranged above a contact tray, said separation tray having means to separate entrained liquids from the upwardly moving vapor and means to return the thus separated liquid to a contact tray below, wherein the means to separate liquid from the vapor comprise a separation device having vapor inlet means, demister means to separate liquid from a substantially horizontal moving vapor, means to discharge the obtained vapor poor in liquids to a contact tray above the separation tray and means to collect the separated liquids at a lower end of the separating device, which collecting means are in fluid communication with the means to return the thus separated liquid to a contact tray below.

### FIELD OF THE INVENTION

The present invention relates to a column for counter-currently contacting gas and liquid comprising a plurality of horizontal contact trays arranged axially spaced apart in the column, each contact tray being provided with passages, and which column is further provided with a plurality of horizontal separation trays, each separation tray being spatially arranged above a contact tray, said separation tray having means to separate entrained liquids from the upwardly moving vapor and means to return the thus separated liquid to a contact tray below.

### BACKGROUND OF THE INVENTION

These types of trays are known from WO-A-9525571. This publication describes a separation tray consisting of a plurality of swirl tubes and with means for removing liquid from the separation tray. Each swirl tube is provided with an annular U-turn deflector arranged over the upper end of the swirl tube. A swirl tube is a circle cylindrical pipe in which swirl imparting means are arranged. During normal operation gas with entrained liquid flows through the swirl tube, and the swirl imparting means cause the gas to rotate; under influence of centrifugal forces entrained liquid moves away from the centre of the swirl tube and is collected on the inner surface of the circle cylindrical pipe where a film of liquid is formed. At the upper end of the pipe the liquid film breaks up and liquid droplets move away from the pipe and the upwardly moving vapor. The liquid droplets fall on the separation tray from which the liquid is transported back to a lower contacting tray.

Although the efficiency of the above described gas/liquid contacting column is satisfactory a high pressure drop is observed over the trays.

### SUMMARY OF THE INVENTION

The object of the present invention is a column having a satisfactory efficiency and a lower pressure drop than the pressure drop observed for the column as described in WO-A-9525571.

The above object is achieved with the present invention which involves a column for counter-currently contacting gas and liquid comprising a plurality of horizontal contact trays arranged axially spaced apart in the column, each contact tray being provided with passages, and which column is further provided with a plurality of horizontal separation trays, each separation tray being spatially arranged above a contact tray, said separation tray having means to separate entrained liquids from the upwardly moving vapor and means to return the thus separated liquid to a contact tray below, wherein the means to separate liquid from the vapor comprise a separation device having vapor inlet means, demister means to separate liquid from a substantially horizontal moving vapor, means to discharge the obtained vapor poor in liquids to a contact tray above the separation tray and means to collect the separated liquids at a lower end of the separating device, which collecting means are in fluid communication with the means to return the thus separated liquid to a contact tray below.

The column according to the invention has a separation tray wherein the separation is not performed by means of swirl tubes but by means of a vapor demister. This is advantageous because the demister means have a much lower pressure drop than the swirl tubes used in the column as described in WO-A-9525571. A further advantage is that the separation tray used in the column according the invention can be constructed having a much smaller height than the separation tray with the swirl tubes. This is advantageous because column height of a column having the same number of trays can be reduced. Furthermore existing columns having a small tray spacing and having no separation tray above a contacting tray can be easily retrofitted to a column according to the invention.

### BRIEF DESCRIPTION OF THE DRAWINGS

FIG. 1 shows schematically a cross-sectional view of part of a preferred embodiment of the column according to the present invention.

FIG. 2 is a cross-sectional view as in FIG. 1 of part of the separation tray and one demister means.

FIG. 3 is a view from above of cross-section AA′ of FIG. 1.

FIG. 4 is a three-dimensional view of the part of the separation tray of FIG. 3.

FIG. 5 is a cross-sectional view of a column according to the invention provided with contacting trays having multiple rectangular downcomers.

### DETAILED DESCRIPTION OF THE INVENTION

The column is provided with inlets and outlets for fluids. The position of the inlets and outlets depends on the use of the column: when the column is used to remove contaminants from a gas mixture by counter-currently contacting the gas mixture with a liquid absorbent the column has a gas inlet and a liquid outlet arranged in its lower end and a liquid inlet and a gas outlet arranged in its upper end. When the column is used for distilling a feed the column has a feed inlet arranged near its middle part, a gas inlet and a liquid outlet arranged in its lower end and a liquid inlet and a gas outlet arranged in its upper end.

In a column, for counter-currently contacting gas and liquids, gas flows upwards and liquid flows downwards through the column. To allow contacting of upwardly flowing gas and downwardly flowing liquid, the column is provided with a plurality of horizontal contact trays arranged axially spaced apart in the column. Such a contact tray can be a so-called crossflow contact tray or a so-called counter-current contact tray. A crossflow contact tray is provided with gas passages and one or more downcomers which opens below the contact tray, wherein during normal operation gas flows upwards through openings in the contacting tray and liquid flows from the contact tray downwards through the downcomer to the contacting tray below. A counter-current contact tray is provided with openings and with no downcomer, wherein during normal operation gas flows upwards through the openings in the tray and liquid flows downwards through the same openings.

The openings in the contacting tray may be any kind of openings known to be used in the field of distillation trays, like for example sieve tray openings, bubble cap openings, valve tray openings and fixed-valve openings. Examples of suitable openings are described in U.S. RE-27908, U.S. Pat. No. 3,463,464, U.S. Pat. No. 5,454,989, U.S. Pat. No. 5,120,474, WO-A-9828056 and WO-A-9737741.

A cross-flow contacting tray is preferably provided with an overflow weir positioned on the boundary of the area provided with passages and the downcomer. An overflow weir is a vertically extending strip which ensures that during normal operation a predetermined level of liquid is present on the contacting tray. In a column provided with a crossflow contact tray gas flows upwards through the passages of the contact tray and liquid is supplied onto the contact tray through the downcomer of the next higher contact tray. Liquid collected on the contact tray forms a layer and contacting of gas and liquid takes place in the layer of liquid on the contact tray. The thickness of the liquid layer will be determined by the height of the overflow weir, if present. Liquid will be discharged from the contact tray via the downcomer, and vapor disengaged from the liquid on the contact tray flows upwards to the separation tray just above.

The vapor moving upwards from a contacting tray will contain entrained liquid droplets which are de-entrained, or separated, by the separation tray so that the vapor can rise to the next vertically higher contacting tray and the de-entrained liquid can flow by way of gravity to a vertically lower contacting tray. This de-entrainment step is accomplished by making use of the demister separation means. The demister separation means suitably comprise a vertical arranged vapor inlet opening, a separator and a space to collect vapors poor in liquids, all arranged in one horizontal plane and a liquid collector arranged below the separator. The space to collect vapors poor in liquids is in fluid communication with the space above the separation tray. The liquid collector is in fluid communication with a contact tray below said separation tray. The form of the separator may be for example annular or rectangular. Annular designs will have a space to collect vapors in its centre. Rectangular designs are preferably arranged in pairs, wherein two rectangular separators are arranged parallel with a common space to collect vapors in between. In use vapor flows horizontally through the separator wherein the entrained liquid is caught on a surface of said separator. The thus caught liquid subsequently flows by gravity into the liquid collector. By varying the height of the vertically arranged vapor inlet opening the vapor velocity can be reduced to a sufficient level at which the entrained droplets can be separated from the vapor.

The separator of the demister means may be any device which can separate entrained liquid from a horizontally moving vapor. Examples of suitable separator demister means are knitted meshes, for example made from metal or plastic, structured packing or random packing placed in a suitable container. The separator demister means are preferably formed from more than one parallel arranged vertical corrugated plates, with the axes of the corrugation running vertically. The corrugated plates can be made from Fiberglas or plastics. Preferably the corrugated plates are made from metal, for example stainless steel. In use, the vapor and the entrained liquid droplets flow horizontally through the vertical plates and are forced to make successive turns at the bends of the corrugated plates, which are bent at an angle of preferably between 80 and 110 degrees. The entrained liquid droplets, having a greater mass than the vapor are thrown from the vapor flow as that stream turns through the inside of the mist eliminator and the liquid droplets strike the plates. The liquid droplets then drain down the face of the plates due to gravity. Preferably a u-formed vertical gutter is present on the inner bend of the corrugated plate having the open end pointing towards the direction of the horizontal vapor flow. This U-formed gutter inhibits the re-entrainment of the liquid droplets in the vapor flow. Thus, the vapor flow which exits the demister means, has a lower content of entrained liquid.

Liquids removed from the vapor in the separation tray are discharged to a contacting tray below. In columns operating at low liquid loads the de-entrained liquid can be discharged to the contacting tray just below the separation tray. Preferably a liquid seal will then be present somewhere between the separation tray and the liquid discharge end. In a column operating at a higher liquid loading the de-entrained liquid is preferably discharged to the second contacting tray below the separation tray. When using cross-flow contacting trays in combination with high liquid loading, de-entrained liquids are preferably discharged into the downcomers of the contacting tray just below the separation tray. The vapors poor in liquids obtained in the separation tray are discharged upwardly to the next upper contacting tray wherein the above process is repeated.

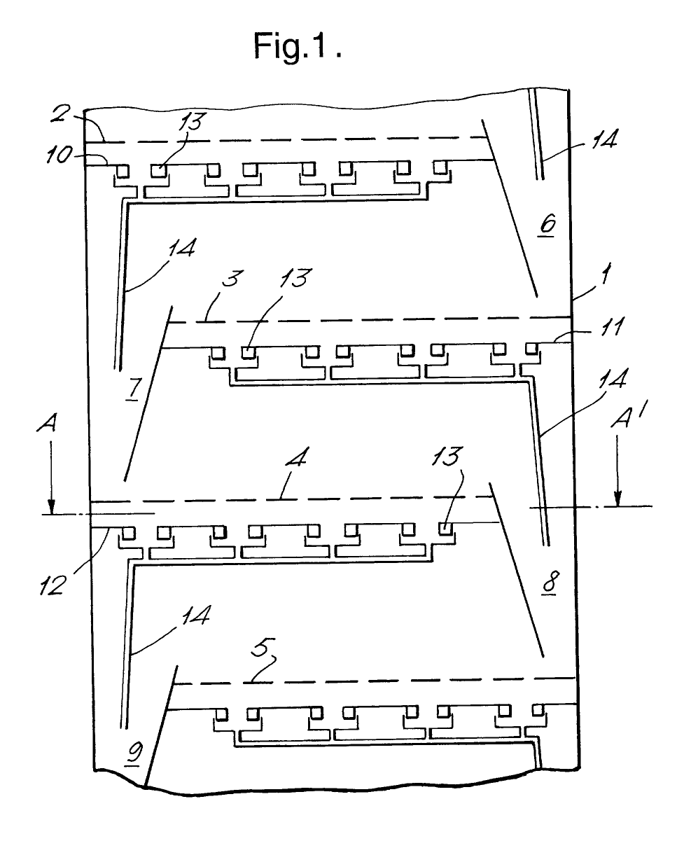

Reference is now made to FIG. 1. The column 1 is provided with horizontal contact trays 2, 3, 4 and 5 arranged axially spaced apart in the column 1. The horizontal contact trays 2, 3, 4 and 5 are so-called sieve trays. A sieve tray is a flat plate provided with passages in the form of holes in it; for the sake of clarity the holes in the plates have not been referred to by reference numerals. The horizontal contact trays 2, 3, 4 and 5 are provided with downcomers 6, 7, 8 and 9 respectively. The downcomer 6 opens below the contact tray 2 onto the next lower contact tray 3, and so on. The tray in which downcomer 9 opens is not shown, and in practice the downcomer pertaining to lowermost separation tray of the column will open into the lower part of the column.

Column 1 is furthermore provided with horizontal separation trays 10, 11 and 12, each separation tray 10, 11 and 12 being arranged above a contact tray 3, 4 or 5. The separation tray 10, 11 and 12 is further provided with one or more demister means 13. The separation trays 10, 11 and 12 are closed apart from the demister means 13, such that when in use, the upwardly moving vapor will only pass the separation tray (10, 11, 12) via the demister means 13. The demister means 13 is fluidly connected to a liquid discharge conduit 14 through which de-entrained liquids are discharged into the downcomers 6, 7, 8 and 9 respectively. Via the downcomer the liquid flows to the contact tray just below the contact tray from where the liquid was entrained by the upwardly moving vapor.

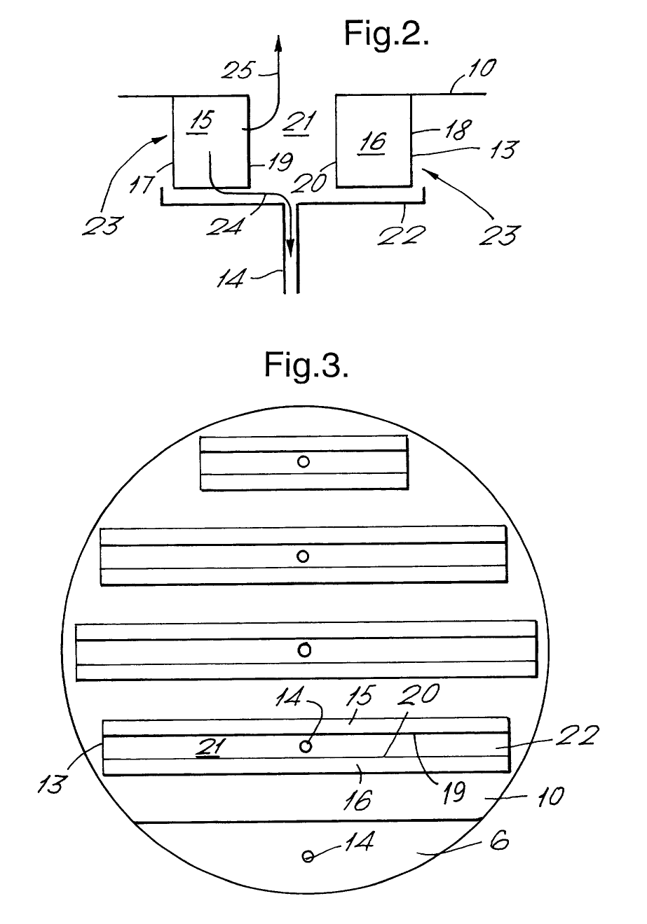

FIG. 2 shows a preferred demister means 13 and part of separation tray 10. The demister means 13 consists of two horizontal, parallel and spatially arranged rows 15 and 16 of rectangular separators. Separator rows 15 and 16 have opposite vertical vapor inlet openings 17 and 18 and opposite vapor outlet openings 19 and 20. The outlet openings 19 and 20 discharge vapors into a common space 21 to collect vapors poor in liquids. This space 21 is in fluid communication with the space above the tray 10 through an opening in the separator tray 10. The demister means 13 is further provided at its lower end with a liquid collector 22 to collect the de-entrained liquid. The liquid collector 22 is in fluid communication with liquid discharge conduit 14. In use vapors and entrained liquids 23 will enter the demister means 13 thereby passing the separator rows 15,16 horizontally. In separator rows 15,16 liquid 24 is de-entrained and falls to the liquid collector 22 from where it flows into the liquid discharge conduit 14. The vapors 25 leave the separator rows 15,16 via openings 19,20 and flow upwards vertically passing the separator tray 10.

FIG. 3 shows the cross-sectional view AA′ of FIG. 1. The Figure shows three parallel arranged separator means 13 and the closed separator tray 10 provided with rectangular openings to spaces 21. The figure also shows the downcomer 6 and the liquid discharge conduit 14 placed in the downcomer 6.

FIG. 4 is a worked open top view of a demister means 13. Two rows of separators (15,16) are shown, which separators consist of vertically parallel plates 25 of corrugated metal with the axes of the corrugation running vertically. In use, the vapor and the entrained liquid droplets 23 flow horizontally through the vertical plates and are forced to make successive turns at the bends 26 of the corrugated plates. The illustrated plates are bent at a 90 degree angle. The de-entrained liquid droplets, having a greater mass are thrown from the vapor flow as that stream turns through the separator rows 15,16 and the liquid droplets strike the plates. The liquid droplets 24 then drain down the face of the plates to the liquid collector 22 due to gravity. Thus, the vapor flow 25 which exits the demister means, has a lower content of entrained liquid.

In an even more preferred embodiment a u-formed vertical gutter (not shown) is present on the inner bend of the corrugated plate 25 having the open end pointing towards the direction of the horizontal vapor flow. This U-formed gutter inhibits the re-entrainment of the liquid droplets in the vapor flow.

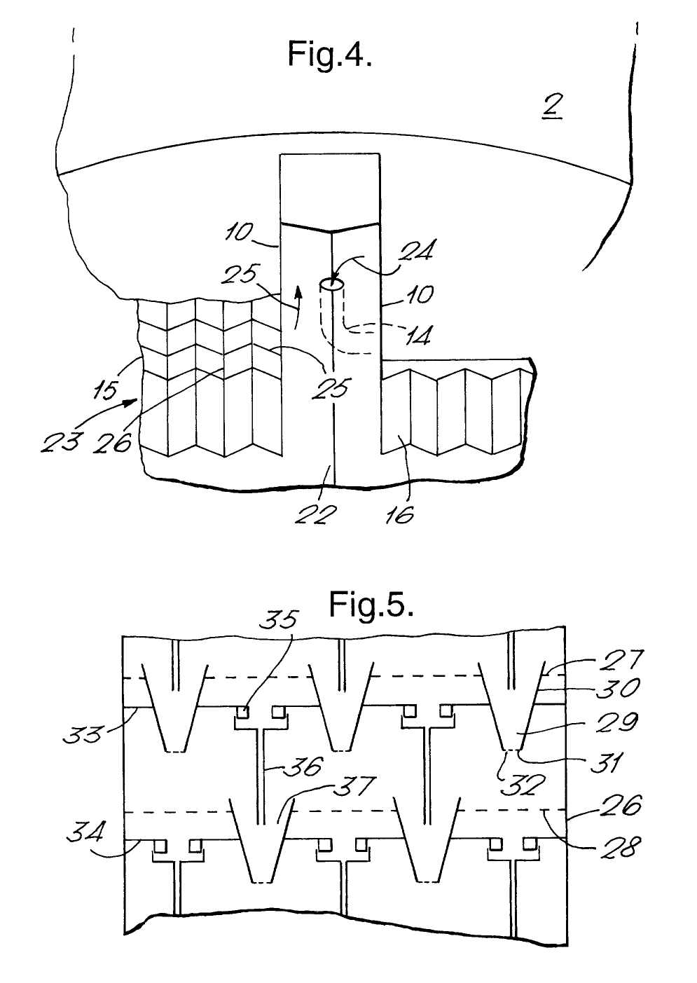

FIG. 5 illustrates a preferred embodiment of the present invention. Contact trays 27,28 are provided in column 26 with a plurality of parallel arranged rectangular downcomers 30. The rectangular downcomers can be arranged in one or two rows on the tray. If they are arranged in two rows the tray layout is preferably a so-called staggered layout. The downcomers 30 have a truncated lower end having a cover 31 and downward directed liquid discharge openings 32 above the lower contact tray 28. Below contact trays 27,28 separation trays 33,34 are present. Separation tray 33 is provided with demister means 35 and a liquid discharge conduit 36 which terminates at its lower end in a downcomer opening 37 of lower contact tray 28.

I claim:

1. A column for counter-currently contacting gas and liquid comprising:
a plurality of horizontal contact trays arranged axially spaced apart in the column, each contact tray comprising passages; and,
a plurality of horizontal separation trays, each separation tray being spatially arranged in the column above a contact tray, each tray comprising:
means to separate entrained liquids from upwardly moving vapor comprising:
a separation device comprising a vapor inlet means;
demister means to separate liquid from a substantially horizontal moving vapor;
means to discharge the obtained vapor poor in liquids to a contact tray above the separation tray; and,
means to collect the separated liquids at a lower end of the separating device, which collecting means are in fluid communication with a means to return the separated liquid to the contact tray situated below the tray above.

2. The column of claim 1, in which the demister means comprises vertically parallel plates of corrugated metal with the axes of the corrugation running vertically.

3. The column of claim 2, in which a u-formed vertical gutter is present on an inner bend of the corrugated plate having an open end pointing towards the direction of the horizontal vapor flow.

4. The column of claim 3, in which the means to separate liquid from the vapor comprises one or more separation banks comprising two horizontal, parallel and spatially arranged rows of demisters comprising opposite substantially vertical vapor inlet openings such that vapors will flow horizontally through the two rows of demisters towards a common space between said demisters, which space is fluidly connected with the space above the separation tray through a vapor outlet conduit.
